(19) United States
(12) Patent Application Publication
(10) Pub. No.: US 2009/0193345 A1
(43) Pub. Date: Jul. 30, 2009

(54) COLLABORATIVE INTERFACE

(75) Inventors: Paul Wensley, Mill Valley, CA (US); Robert M. Goldstein, Los Angeles, CA (US); Jon M. Bloodworth, Santa Fe, NM (US)

Correspondence Address: PATENT LAW OFFICES OF MICHAEL E. WOODS, 16 Hazel Ct., San Rafael, CA, 94901-5223, US

(73) Assignee: Apeer Inc., San Francisco, CA (US)

(21) Appl. No.: 12/360,840

(22) Filed: Jan. 27, 2009

Related U.S. Application Data
(60) Provisional application No. 61/024,148, filed on Jan. 28, 2008.

(51) Int. Cl. G06F 3/00

(52) U.S. Cl. 715/756

(57) ABSTRACT

A communications network, coupled to a first and a second port, for communicating a media resource; and a first and second real-time communication client, coupled respectively to the first and second ports, each of the clients including: a communications subsystem for receiving the media resource; a renderizer subsystem, responsive to a control signal, for rendering the media resource; an interface for generating the control signal; and a synchronization subsystem for communicating the control signal; wherein a first one of the communications clients generates the control signal and communicates the control signal to the second one communications client to render the media resource in substantial synchronization on the communications clients.

### CROSS REFERENCE TO RELATED APPLICATIONS

This Application is related to U.S. patent application Ser. No. 11/164,645 filed on Nov. 30, 2005, U.S. patent application Ser. No. 11/309,529 filed Aug. 18, 2006, U.S. patent application Ser. No. 11/564,842 filed Nov. 30, 2006, and U.S. patent application Ser. No. 11/564,843 filed Nov. 30, 2006, all of which are incorporated in their entireties by reference for all purposes.

### BACKGROUND OF THE INVENTION

The present invention relates generally to real-time collaboration systems, and more particularly to an interface and system enabling simultaneous and concurrent multi-user multi-way collaboration system capable of operation incorporating one or more electronic devices having network connectivity to synchronize substantially a unified rendering of a plurality of media resources across all the collaboration systems.

The incorporated patent applications referenced above describe a robust system architecture that provides for a wide-ranging and expanding set of innovative applications. There are many different types of collaboration systems, many focused on specific/narrow applications. The systems are usually limited by the type of device and/or the type of resource that may be shared, as well as how that/those resource(s) is/are shared. For example, in conventional systems, the architecture provides for a presenter mode. The presenter mode does not enable multiple users to simultaneously interact and collaborate as one user is in control. Control has to be explicitly passed to enable another user to “present” to the other users. A simple user system that incorporates elements of peer-to-peer and client-server paradigms with a unitary interface for true seamless real-time simultaneous and concurrent collaboration among several users, an effective electronic conversation among these participants in which media files and other resources are integrated, has been lacking.

What is needed is a combination of an interface and a system architecture that enables simultaneous concurrent multi-user multi-way real-time collaboration permitting distributed users to easily and efficiently share multiple resource types, and any editorial comment on them, natively within the interface.

### BRIEF SUMMARY OF THE INVENTION

Disclosed is a system, method, and computer program product for an interface and a system architecture that enables simultaneous concurrent multi-user multi-way real-time collaboration permitting distributed users to easily and efficiently share multiple resource types, and any editorial comment on them, natively within the interface.

Specifically, a communications network, coupled to a first and a second port, for communicating a media resource; and a first and second real-time communication client, coupled respectively to the first and second ports, each of the clients including: a communications subsystem for receiving the media resource; a renderizer subsystem, responsive to a control signal, for rendering the media resource; an interface for generating the control signal; and a synchronization subsystem for communicating the control signal; wherein a first one of the communications clients generates the control signal and communicates the control signal to the second one communications client to render the media resource in substantial synchronization on the communications clients.

Another aspect of the present invention includes a communications network, coupled to a first plurality of ports, for communicating a second plurality of media resources, the second plurality of media resources including resources implemented in at least two different media formats; and a third plurality of real-time messaging clients coupled to the first plurality of ports of the communications network, each of the clients including both a communications subsystem for receiving the second plurality of media resources and an interface for rendering all of the second plurality of media resources, each the client producing renderings of the media resources in its interface in substantial synchronization resource renderings in all the other interfaces of all other the clients.

The preferred embodiments of the present invention create a more natural “collaborative environment” for those that work or play with digital media files to review, comment upon, discuss, and make decisions respecting those media files, particularly when sharing/exchanging media content with others in any context. One applicable paradigm, provided to facilitate understanding, is the real-world experience of working on the same tabletop with the other users, sharing media, viewing, commenting, viewing and/or playing media together and in synchronization and interacting and collaborating with one another. It is recognized that a modern workgroup cannot easily be at the same “tabletop” as all of the others, and that having the tools available on desktops and mobile devices as needed/desired by the users is important for true simultaneous and concurrent real-time interactivity.

### BRIEF DESCRIPTION OF THE DRAWINGS

FIG. 1 is a computer system that may function as a basic computer in implementing the present invention;

FIG. 2 is a generalized diagram of a portion of a network system (e.g., the Web or the Internet) to which a computer controlled display terminal used for transmitting or receiving messages is connected;

FIG. 3 is a functional block diagram of the APEER server shown in FIG. 2;

FIG. 4 is a functional block diagram of the APEER client shown in FIG. 2;

FIG. 5 is a close-up of an APEER client with an interface supporting the local session shown in FIG. 4;

FIG. 6 illustrates menu details of a “me” button after actuation;

FIG. 7 illustrates menu details of a “media” button after actuation; FIG. 8 illustrates menu details of a “contacts” button after actuation;

FIG. 9 illustrates menu details of a “sessions” button after actuation;

FIG. 10 illustrates menu details of a “tools” button after actuation;

FIG. 11 illustrates menu details of an “IM” button included in a menu bar of the interface;

FIG. 12 illustrates a “voice” button included in the menu bar; and

FIG. 13 illustrates a “help” button included in the menu bar.

### DETAILED DESCRIPTION OF THE INVENTION

The present invention relates to a real-time concurrent multi-user multi-way collaboration system enabling simultaneous operation incorporating one or more electronic network devices preferably including devices having wireless network connectivity to permit distributed users to easily and efficiently share both content and editorial input on such content in real-time. Specifically, a real-time concurrent multi-user multi-way collaboration system, method, and computer program enabling simultaneous operation providing two or more users to be able to unambiguously collaborate in the rendering of a media resource, such that any user at any time may set a rendering of the media resource to a desired reference on all participating clients. The following description is presented to enable one of ordinary skill in the art to make and use the invention and is provided in the context of a patent application and its requirements. In the context of explaining the preferred embodiment(s), two generally synonymous words (“simultaneous” and “concurrent”) have been used to connate the ideas that the preferred embodiments support multiple users active at the same time (simultaneous) and that the actions of each user is reproduced to all the other users in substantial real-time (concurrent). These meanings are used in interpreting the preferred embodiments except where the context suggests otherwise or is expressly described as operating differently. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the incorporated patent applications referenced above, several of the architecture elements are similar to those described herein. Unless the context suggests otherwise, or differences are expressly noted, the APEER Server described herein includes all the elements and features of the APEER Server set forth in the incorporated patent applications. The APEER Client described herein includes all the elements and features of the APEER Client set forth in the incorporated patent applications.

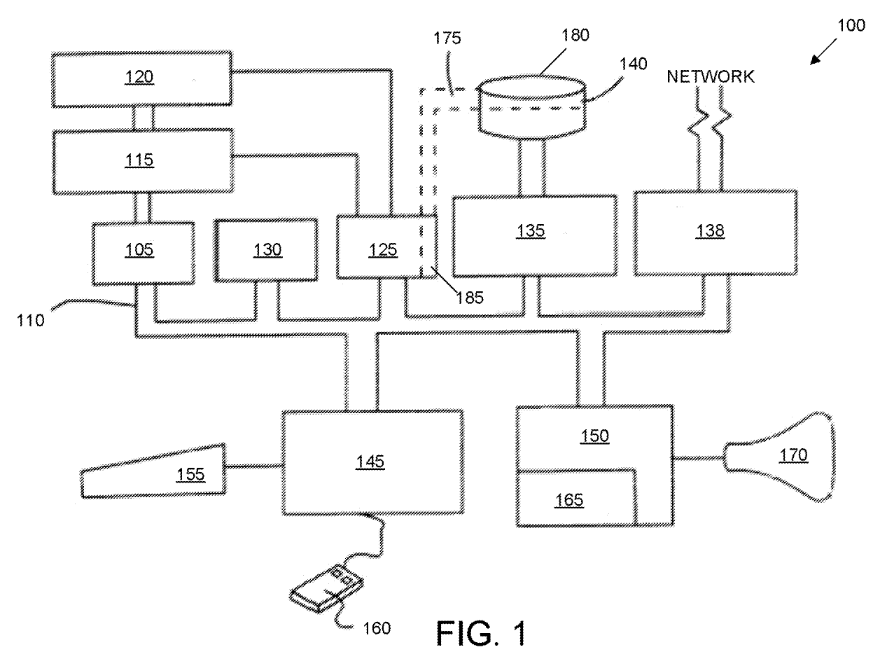

FIG. 1 is a computer system 100 that may function as a basic computer in implementing the present invention. Computer system 100 includes a central processing unit (CPU) 105, such as one of the PDA (personal digital assistant) microprocessors, PC microprocessors or workstations, e.g. Intel™ PXA270 312 MHz processor used in a Treo™ 650 portable electronic device or other microprocessor or microcontroller or controller used in other devices (e.g., an Apple iPhone), is provided and interconnected to various other components by a system bus 110. An operating system 115 runs on CPU 105, provides control and is used to coordinate the function of the various components of FIG. 1. Operating system 115 may be one of the commercially available operating systems such as the Palm OS available from PalmSource, Inc.; Microsoft's Windows, as well as UNIX and AIX operating systems, and the like. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160 or a joystick, remote keypad, game controller, stylus, button navigations system, or the like) are all interconnected to bus 110 through user interface adapter 145. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 (or other input device) or mouse 160 (or other pointing system) and receiving output information from the system via display 170. The system also contains a memory cache 175 which is illustrated as a dashed line outline and includes a portion 180 of a disk storage drive 140 and a portion 185 of RAM 125.

As noted above, preferred embodiments of the present invention may use a wide range of computing systems. One particular embodiment is most preferred, namely a use of one or more wireless-network-connected electronic devices (e.g., portable or mobile computing system) in communication with a server application and optionally one or more desktop/workstation personal computers. Client applications are supported by the electronic device and communicate via a wireless network connection, as described in more detail herein. An example of a suitable portable electronic device is represented by a Treo 650 smartphone available from Palm, Inc. (http://www.palm.com) and other similar devices. While the present invention contemplates use of virtually any suitable network-compatible computing system having a display of reasonable resolution and color depth (preferably color) such as, to simplify the discussion the computing system described in the preferred embodiments will be the Treo 650-type device. When a quality of the screen is poor (e.g., a relatively few number of colors or limited resolution) or when a bandwidth of the network communications is limited, the quality of the experience is also more limited than would be the case with improved display and/or bandwidth. In some embodiments and implementations, client applications, or server functions when present, may convert content from one system to another in an appropriate form/format.

The Treo™ 650 smartphone from Palm, Inc. combines a compact wireless mobile phone with email, organizer features, messaging, and web access. Also included is Bluetooth® technology so a user may connect wirelessly to other Bluetooth devices. Additional features include an MP3 player, a digital camera that captures video, and a color screen that is responsive to a stylus for controlling the system (alternatively a keypad may also be used for a system interface)—all in a device that is still small enough to fit in a pocket of the user. In some implementations, a “smartphone” implementation is not necessary by adapting the user interface elements consistent with the input and display features of the portable electronic device. In other implementations, the interface is adapted to operate with other interface elements, for example a “touch” screen in addition to, or in lieu of, a stylus.

Additionally to simplify the following discussion, it is noted that the present invention contemplates use on many different communications networks, both public and private. In some implementations, multiple different types of network systems may be used together, and the server may, for example, bridge different communications networks and translate/convert between different protocols/formats to exchange messages between the devices and to exchange communications with any device. In the following example, use of the Internet accessed through wireless access points using is described as the preferred embodiment though other configurations are within the scope of the present invention.

Before going further into details of specific embodiments, set forth below is a general perspective of the various elements and methods that may be related to the present invention. Since a major aspect of the present invention is directed to network communications, preferably Internet communications using Internet and/or Web protocols, and use of data messaging similar to access of Web pages, an understanding of such networks and their operating principles may be helpful. The following does not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

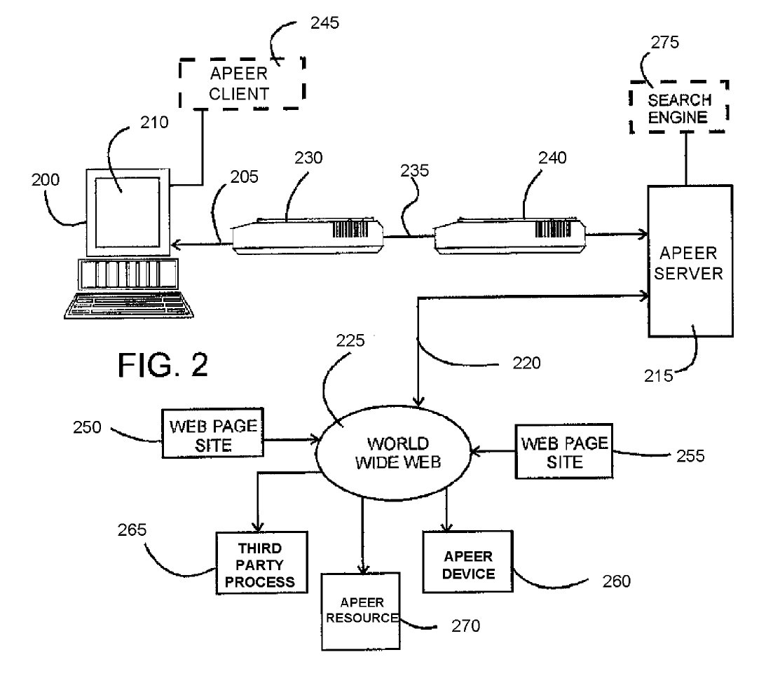

FIG. 2 is a generalized diagram of a portion of a network system (e.g., the Web or the Internet) to which a computer controlled display terminal 200 used for transmitting or receiving messages is connected. Computer display terminal 200 may be implemented by computer system 100 shown in FIG. 1 with a connection 205 (FIG. 2) equivalent to the network connection shown in FIG. 1. For purposes of the present embodiment, computer 200 serves as a client station and has received and displayed a local session 210. Reference may be made to the above-mentioned Mastering the Internet, pp. 136-147, for typical connections between local stations to the Web via network servers, any of which may be used to implement the system on which this invention is used. The system embodiment of FIG. 2 has a network connection (e.g., dial-up or direct broadband). Such host connections have been in use for over 30 years through network access servers 215 that are linked 220 to a network 225 (e.g., the Web). Servers 215 may be maintained by a service provider to the client's display terminal 200. Server 215 is accessed by client terminal 200 through a normal communications linkage 205 via, for example, a modem 230, a telephone line 235, and a modem 240, though as noted above it is most preferable to implement the communications subsystem using wireless protocols as well known to support data exchanges. A local data structure representative of local session 210 has been developed at terminal 200 through an APEER server 215 via the communications linkages from server 215, which may have accessed them from network 225 via linkage 220. An APEER client program 245 operates within terminal 200 to control the communication with server 215 to thereby transceive and process (e.g., display) the local session 210 on terminal 200. Also communicated to network 225 are web page site 250 and web site 255, where remote resources are stored and accessible to computing systems of the present invention. In addition, the system includes one or more additional APEER clients (e.g., APEER device 260), third-party processes 265 (e.g., printing, archiving, and the like), and additional APEER resources 270 also available to the computing systems of the present invention.

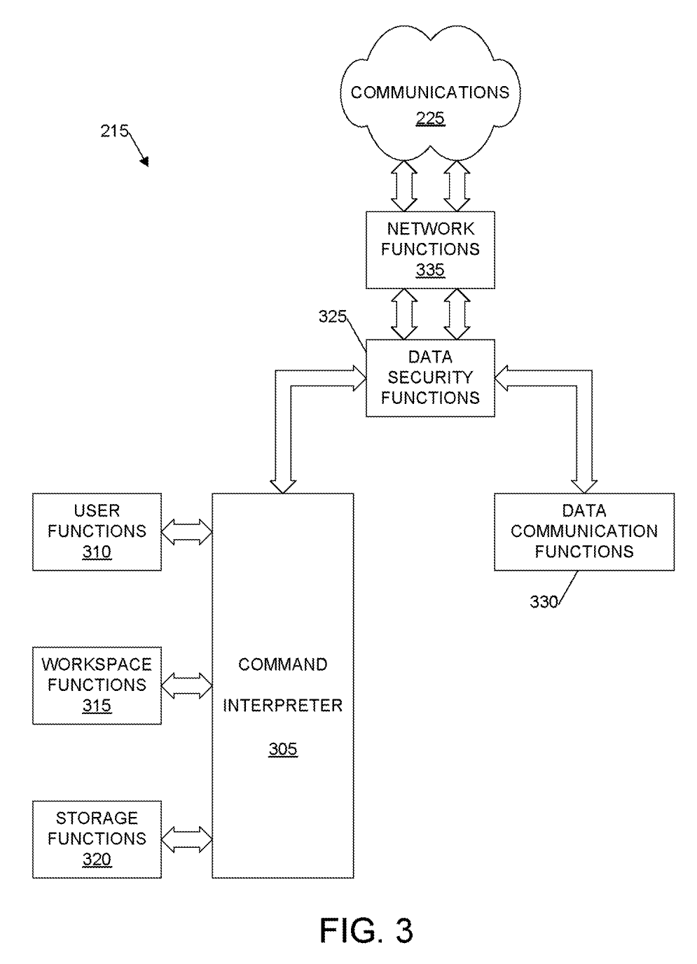

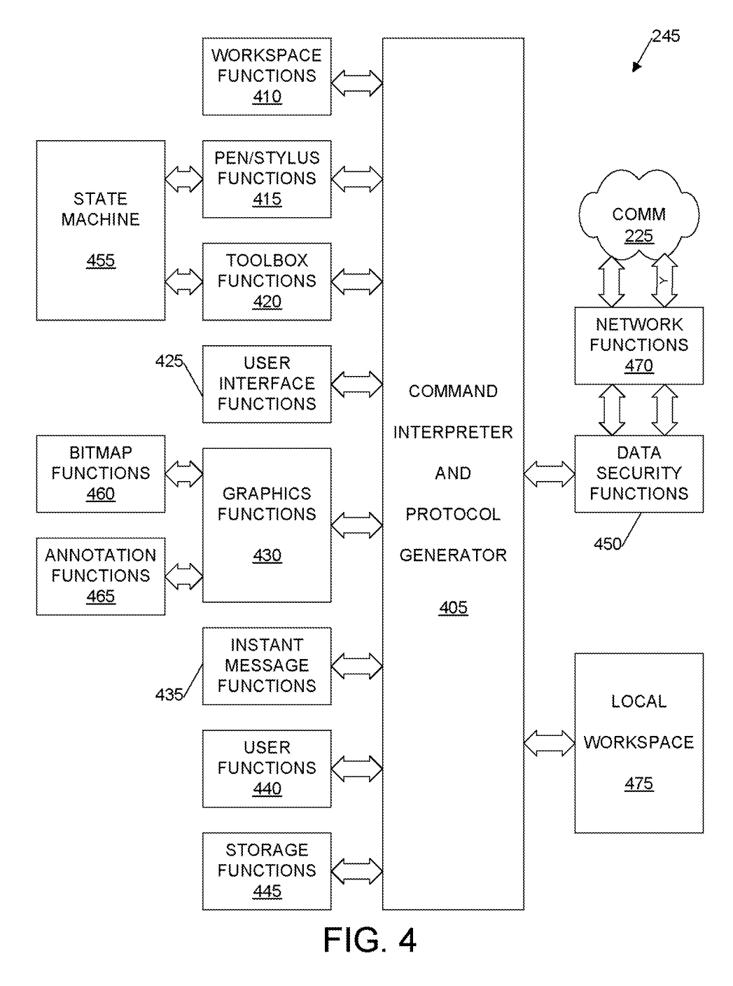

With this setup, the present invention, which will be subsequently described in greater detail with respect to FIGS. 3 and 4, will be carried out using a plurality of APEER clients 245 communicating to one or more APEER servers 215 and one or more other APEER devices 260 and optionally other resources as shown in FIG. 2. As described in more detail below, any particular APEER client 245 connects to a data structure of APEER server 215 using appropriate messaging protocols (and often requires login credentials for access) and thereafter all APEER devices 260 (including terminal 200 supporting APEER client 245) also communicated to the same data structure directly exchange messages with each other through APEER server 215 to control a content of a local session 210 of each APEER device 260.

A feature of a preferred embodiment of the present invention is support for natural and instant ad hoc collaboration networks that setup simply and exist only as long as desired. A first participant uses an APEER client to create a session (with any access controls) with desired content and provides an invitation or access information to other participants. As these other participants join the session, the content is reproduced in each local session of each joining APEER client. Each user participates in the session and as the other participants leave, the content from the session of the leaving participant is removed from the device supporting the local session, leaving no presence behind. (In some embodiments, local resources reproduced by the communications clients may be temporarily or permanently retained on one or more clients that participated in the session, depending upon implementation and rights management features and use). The first participant may use content from a removable memory system operable with the electronic device supporting the APEER client to optionally leave no copy of the desired client and/or content on the electronic device. In some instances, the APEER client is operable from the removable memory system as well. Thus these ad hoc collaboration networks have low resource requirements, are created easily, and may be configured to leave no trace of the clients or of the content on supporting electronic devices as the network is dismantled—a non-persistent network with non-persistent content that enhances data security and ensures that each ad hoc network includes the latest and most current content available to the originator/creator.

FIG. 3 is a functional block diagram of APEER server 215 shown in FIG. 2. APEER server 215 according to the preferred embodiment is an application written in the C++ programming language, supported by one or more computing systems described herein, and does not require use of a graphical user interface. APEER server 215 is implemented as command-line based and preferably outputs any information to a log file, though other implementations may provide for other interface types and functions. Source code and related resources for APEER server 215 are compiled and executable on Windows, Linux and Unix computers, and the like.

APEER server 215 includes a command interpreter 305 coupled to a set of user functions 310, a set of session functions 315, a set of storage functions 320, and a set of data security functions 325. A set of data communication functions 330 is also coupled to data security functions 325. Data security functions 325 are coupled to send and receive via network 225 through use of a set of network functions 335.

Command interpreter 305 processes buffers of data that have been read from the communications channels and assembles them into correctly formed APEER packets. This includes combining several packets into a single packet in some implementations. The packets are checked that they are well formed and then dispatched according to their operation code.

User functions 310 include those functions related to managing and checking user logins and parameters. This includes functions such as “Request User ID”, “Request User Color”, “User Disconnected” and others. Users and/or their operations are preferably tagged (e.g., by color or name label or similar identifying structure/information provided to other users) during operation.

Session functions 315 encompass those functions for creating and manipulating sessions and their objects (e.g. windows). Example commands include “Create Window”, “Move Window”, “Add Bitmap” and many others.

Storage functions 320 include those functions related to storage and retrieval of sessions. Example commands include “Save Session” and “Restore Session”. Since sessions may be stored on both the server and on the client, these commands work on multiple communications channels.

Data security functions 325 include those functions related to protecting the integrity of both the communications session and the data. This includes functions such as “Verify Password” and the basic data encryption for data packets.

Data communications functions 330 include dissemination (e.g., broadcast or selection distribution or other communication and the like) functions that handle broadcasting of client data to all other clients connected to a session. When a client sends a data command to the session, these functions queue the packet for re-broadcast to all of the connected clients. Since re-broadcast of the packets may send different amounts of data to each client (as their network speeds may be different), care is taken to not duplicate the data or slow the entire re-broadcast to the slowest client.

Network functions 335 include low-level networking routines, including establishing the network connections, detecting when a network connection has been lost, reading and writing data packets, checking for blocked (full) data connections, and the like.

When APEER server 215 starts, it reads any command line arguments and configures one or more communications port that APEER clients will use when communicating with it and through it. Optionally, it creates a new log file for logging errors and information. The type of information that is logged is configurable via the command line, from “errors” to “data flow”.

APEER server 215 includes two roles:
1) Respond to requests for information from APEER clients, such as “Client Connects”, “Join Session” and “Save Session” commands and messages; and
2) Move data from one APEER client to another that are connected to the same session.

As used herein, a session is supported by an APEER server using a data structure that preferably includes a state machine for managing an attachment state of APEER clients communicated to it through one or more of its communications port. An APEER server determines which APEER clients are authorized to route messages to other APEER clients joined to the same communications channel. In the preferred embodiment, each APEER client issues messages and receives messages from an APEER server—sometimes those messages are destined for the APEER server, and sometimes to other APEER clients. The destination is determined by a connection status as reflected in this data structure/state machine/server session. Each APEER client includes one or more local sessions, where in each session one or more local resources exist—the reproduction, manipulation, editing, commenting, and the like by one APEER client on a resource within its local session generates messages reflecting the local processing. These messages are communicated to an APEER server and may, when the client is joined to a data structure that identifies other APEER clients similarly joined, route to these similarly joined APEER clients. In the preferred embodiment, these messages result in duplication of a result of a local processing in all the other APEER clients receiving the messages. Each message has a priority based upon a desire to have it received by the remote client(s) before other lower priority messages. Messages that are generated purely by user interaction, such as window movement, generally take priority over other commands, such as bitmap data. When higher priority messages need to be sent, they are inserted in the queue of outgoing messages in front of any lower priority messages. In this way, the clients are kept more closely synchronized than may be the case should other message queuing paradigms be implemented. Application and implementation details generally determine the relative order of prioritization, such as the user interface element messages from user manipulation of controls over synchronization messages from the renderizers, for example.

Server 215 opens a socket on the requested port and waits for a connection from an APEER client application 245 executing on APEER device 260. When client 245 connects, server 215 creates an internal “connection” and waits for data to be sent. Initially, server 215 interprets all data received via the protocol (below) until it receives an “Join Session” command, in which case that connection is thereafter just used to move data (without interpretation) to other clients 245 also joined to the same session. Each APEER server 215 may support one or more multiple independent server sessions, permitting multiple sets of multiple APEER devices 260 to exchange messages with each other through APEER server 215.

The Protocol

Data is sent to and from the server and other clients via a byte-stream binary protocol. The protocol of the preferred embodiment includes marking packets with begin and end marks (so as to allow for error detection and reconstituting partially received packets) and packet lengths. Inside the packets, data is organized into basic data structures, such as strings, 16 bit integers and 32 bit integers.

Command Interpretation

Command interpretation in the preferred embodiment is similar on an APEER server as it is on APEER clients. Data is read from the clients and assembled into complete commands. Commands are checked for correctness, by checking the start mark, command length and end mark. When, for some reason, the commands are malformed, a command interpreter will move forward in the data received until a correct command is recognized. When a complete command is assembled, a jump table is used to dispatch the command. Individual command functions in turn read and parse the command data from the data buffer that was read.

A special command from an APEER device, “Join Session”, interpreted only on an APEER server, moves the data connection to a session and triggers another mode of operation. This other mode no longer interprets commands in the data received, but instead “broadcasts” them to others that have joined the session. In this way, clients are more closely communicating directly with each other, only using the APEER server as a conduit for data transfer. Data transmissions of this preferred embodiment are more secure, as they are not understood by the server.

Typical commands between server and client(s) of a preferred embodiment include:
Service commands such as, PING, REQUEST_START_TIME and the like;
Session commands such as CLEAR_USER_LIST, ADD_USER_TO_LIST, and the like; and
Registration and login commands such as LOGIN_REQUEST, LOGIN_REQUEST_ACK, LOGIN_ACCEPTED, LOGOUT_ACCEPTED, and the like.

The commands that pass between clients of the preferred embodiments encapsulate an aspect of the nature of the invention and enumerate the type of interactivity and sharing. Typical commands between clients include:
RUNANIMATION,
STOPANIMATION,
MOVEMENTTOTRASH,
ADDAUDIODATA,
PLAYAUDIO,
STOPAUDIO,
SPEED_TRANSMISSION_CTRL,
FOLDERDATA,
ZOOMIN,
ZOOMOUT,
PANUP,
PANDOWN,
PANRIGHT,
PANLEFT,
ADDINSTANTMESSAGE,
DEFAULTUSER,
DEFAULTUSERCOLOR,
OPENFOLDERCOLOR,
IMTEXTDISPLAYCOLOR,
IMTEXTENTRYTIMEOUT,
IMTEXTTIMEOUT,
IMTEXTSIZE,
FILEVERSIONNUMBER,
OFFLINEBACKGROUND,
ONLINEBACKGROUND,
IMBACKGROUND,
IMTEXTENTRYCOLOR,
INTERFACELANGUAGE,
REQUESTSYNC,
DECLAREWINDOW,
REQUESTWINDOW,
CHANGEUSERCOLOR,
VIDEOWINDOW,
ADDSTREAMDATA,
STOPSTREAM,
WHITEBOARDWINDOW,
MOVEWINDOW,
MAXIMIZEWINDOW,
MINIMIZEWINDOW,
RESIZEWINDOW,
DRAWWINDOW,
CREATEWINDOW,
DROPWINDOW,
WINDOWTOLIGHTTABLE,
DESTROYCONTENTS,
ADDBITMAP,
ADDPIXELS,
INFORMATIONMESSAGE,
FILESIZEINFO,
PLAYSTREAM,
CHECKVERSION,
GETAVA,
VOICEDATA, and
PROBE.

The protocol is a general purpose protocol and permits expansion/modification to a number and type of commands as product features are created or implemented. These are simply representative commands for a preferred embodiment of the present invention. Other implementation and embodiments of the present invention may include different or additional commands.

Functionality/Interface Elements:

I. Connecting, that includes:
Finding contacts (Showing who is currently on; Finding them via search; and Sending invitations to download and join APEER);
Creating a session with contacts;
Creating groups;
Creating a session with a group;
Sending invitations (including SMS; and Email); and
Responding to invitations.

II. Exchanging files with contacts and groups (during APEER session), including:
Image;
Document (e.g., PDF, DOC, TXT, PPT, XLS, and the like)
Audio (clips and songs); and
Video (clips).

III. Switching between files.

IV. Viewing files and playing files.

V. Seeing and experiencing what others are viewing and playing (synchronous/concurrent), including:
Watching a user “channel” (including Public channel and Private channel).

VI. Image files, including:
Add comments (e.g., Text comments; Vote; and Emoticons).

VII. Audio files, including:
Playing audio;
Pausing and stopping audio;
Fast forward audio (when necessary/desirable);
Rewind audio (provision for limited rewind-like a single 5 second rewind or other period appropriate for implementation);
Go to the beginning of the audio (may be automatically accomplished when you hit stop); and
Add comments (including Text comments; Vote; Emoticons).

VIII. Video files (same comments as per audio files), including:
Playing video;
Stopping video;
Fast forward video;
Rewind video;
Go to the beginning of the video;
Add comments (including Text comments; Vote; Emoticons).

IX. Persistence (as appropriate/necessary/desirable), including:
Saving channel contents locally;
Restoring channel contents locally; and
Server saved channel contents—12 hour maximum or other period which in some cases may be practically indefinite.

X. Preferences, including:
Saving preferences; and
Restoring preferences.

XI. Instant messages, including:
Sending;
Receiving; and
Stored instant messages—12 hour maximum or other period which in some cases may be practically indefinite.

FIG. 4 is a functional block diagram of APEER client 245 shown in FIG. 2. APEER client 245 according to the preferred embodiment includes a command interpreter and protocol generator 405 coupled to a plurality of sets of functions. These sets of functions include: session functions 410, keypad/pen/stylus functions 415, toolbox functions 420, user interface functions 425, graphics functions 430, instant message functions 435, user functions 440, storage functions 445, and data security functions 450. A state machine 455 is coupled to keypad/pen/stylus functions 415 and to toolbox functions 420. A set of bitmap functions 460 and a set of annotation functions 465 are both coupled to graphics functions 430. Data security functions 450, compatible with data security functions 325, are communicated to network 225 through a set of network functions 470. Interpreter/generator 405 of the preferred embodiment interacts with the plurality of sets of functions described herein to define and manipulate a state of one or more resources made available in a local session 475. These resources either originate locally or are reproduced from messages received from communications network 225 (as noted above, locally originated resources and processing thereto generate one or more messages to replicate the resources and the results of the local processing in other APEER clients joined to the same data structure of an APEER server).

A preferred embodiment of APEER client 245 includes client software that is written in the C++ programming language. Much of the software of the preferred embodiment is general purpose and may be used on Palm, PC, Mac, Symbian, Windows Mobile V5/V6, iPhone, and the like, and other existing and future operating systems. Platform specific routines are used for networking, mouse and pen/stylus input and drawing to the screen.

Client 245 maintains a “display list” of the resources (e.g., images, documents, videos, audio content, instant message sessions, virtual whiteboards, and the like), windows and folders on the display. Commands from the navigation controls (e.g., pen, mouse, scroller wheels, buttons, “touch”, and the like), as well as those from the network are used to manipulate the display list and draw the objects on the screen or perform other interface functions. Each time an action is initiated on the display, such as moving a window, a command is created and sent to the server for use by all other clients that have joined the session. An intent is to keep all clients as closely in sync as possible. Moreover, the network routines work in parallel to the local mouse and pen routines, so that commands from other clients are merged as quickly as possible to keep the display up to date.

Module Breakdown (some of the following may be optional)

Local session functions 610:

These routines manage local session 475, keeping track of the windows that appear on it and their background colors and the like.

Keypad/Pen/Stylus functions 415:

These routines interpret pen/stylus movements and drive state machine 655 to set the state for drawing, dragging windows, and resizing, among other functions.

State machine 455 functions:

These routines manage state machine 455—keeping track of the current mode of the applications, such as dragging, drawing, and the like.

Annotation functions 465:

These routines manage a creation and a display of annotations of resources within local session 675 (e.g., marks on top of the images). There are three types of annotations of the preferred embodiment applicable to an image-type resource—rectangle, freehand, ellipse, circle, text, and note. Note annotations display as a small icon and have text contained in them that may be displayed and edited.

Toolbox functions 420:

These routines handle the display, animation, and selection of tools in a toolbox (a collection of “virtual” tools that interact with the resource(s) of local session 675. Selecting a tool updates state machine 655 for the current “mode” of the application.

Graphics functions 430:

These routines handle all graphics for the application. Most of the functions map onto operating system support functions, such as drawing rectangles, lines, text, and the like. All bitmap functions, except drawing to the screen, such as scaling, are handled internally.

Note that the Palm and the PC have different screen characteristics—the PC being 24 bits deep and the Palm being 16 pixels deep. This has added complication for sending pixels from one type of APEER client to another and may be accommodated by different ways including translation functions in an APEER client or in an APEER server.

Instant message functions 435:

Associated with each resource may be one or more instant messages (e.g., a list). These may be entered and sent to all other users that are connected to the particular session. These routines handle all input and display of the instant messages.

User interface functions 425:

These routines handle the creation, display, and updating of any dialog boxes, alerts, and controls. These routines of the preferred embodiment only use the native operating system support for user interface controls, resulting in slightly different looks on the different versions of APEER (for example because the Palm has a small screen and fairly large fonts).

Storage functions 445:

These routines handle all storage and retrieval of the APEER sessions.

User functions 440:

These routines manage and keep track of the users of APEER—sending and retrieving user information (such as a currently selected color of a user or tagging/labeling user actions/interface operation which are visible to other clients) with all APEER clients and APEER servers may not always be implemented for, or enabled, by some or all users.

Command interpreter and protocol generator 405:

These routines interpret and generate packets of information that have been received and will be sent to other APEER clients and APEER servers. The packet protocol is described above in connection with a description of an APEER server as part of FIG. 3.

Data security functions 450:

These routines implement any data security aspects of receiving and sending on network 305. These include encryption, CRC validation, and the like. For some applications, these are optional.

Network functions 470:

These routines connect, read, write and disconnect from the network. They assemble complete commands from data received and buffer up writes for reliable sending on the network.

External file handling:

These routines handle the import and export of external data resource files—for images/videos these files are stored in standard image formats, such as BMP, JPEG, TIFF, mp3, WMV, and AVI for example. In addition, functions in some embodiments exist for handling import/export/editing/annotation of metadata format types including EXIF data and the like that supports timestamps, keywords, and other metadata for example.

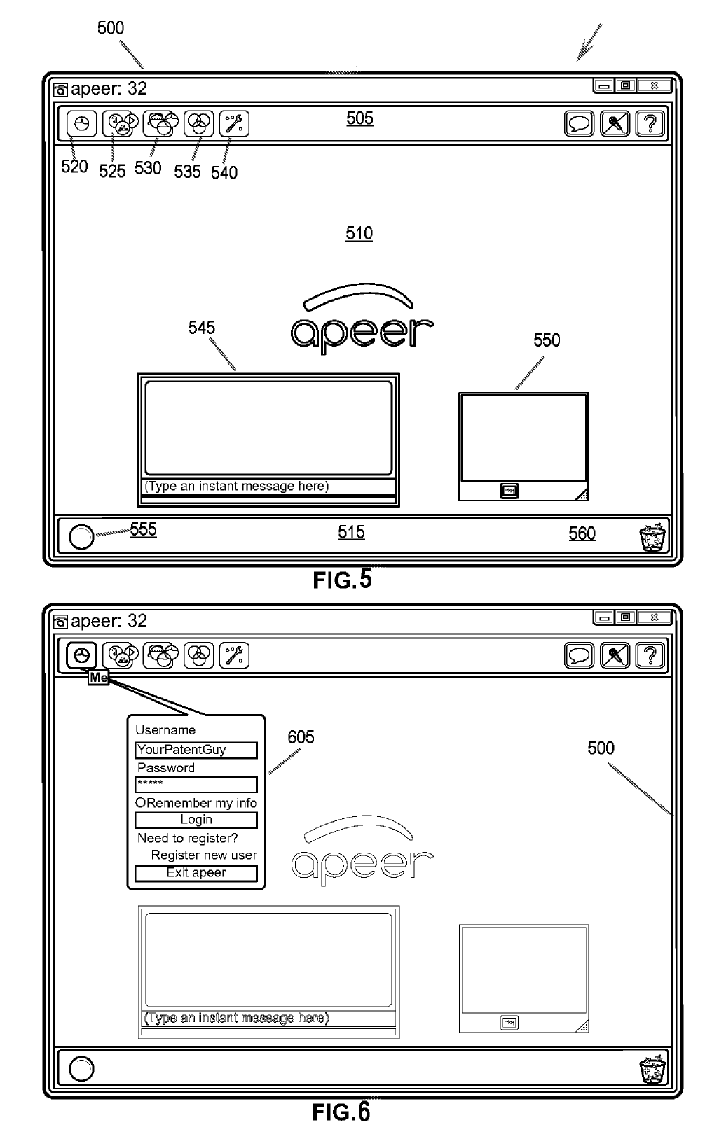

FIG. 5 is a close-up of an APEER client 245 with an interface 500 supporting local session 475 shown in FIG. 4. While different interfaces may support the local session in different ways, interface 500 is one preferred implementation. Interface 500 includes a menu bar 505, a resource space 510, and a session control bar 515. Specifics may vary as to any particular implementation and may include minimize, maximize, restore, close, and the like, in addition to a set of preferred functions described herein.

Menu bar 505 provides easy access a set of various features, including a “me” button 520, a “media” button 525, a “contacts” button 530, a “session” button 535, and a “tools” button 540. Resource space 510 supports the various integrated resource renderizers implemented by the local session, specific to the type of resource. Resources include, for example, text, document (.doc, pdf, ppt, xls, and the like), image, video, audio, and combinations thereof. Resource space 510 is shown to include a pair of common and popular renderizers: an instant message renderizer 545 and a “white board” renderizer 550. Session control bar 515 includes one or more session identifiers 555 and optionally includes a space 560 for identifying participants in the currently active session. Additional details of the bars, controls, and buttons are further described herein.

FIG. 6 illustrates menu details 605 of “me” button 520 after actuation. Options include login details (e.g., username and password and/or create new user/account).

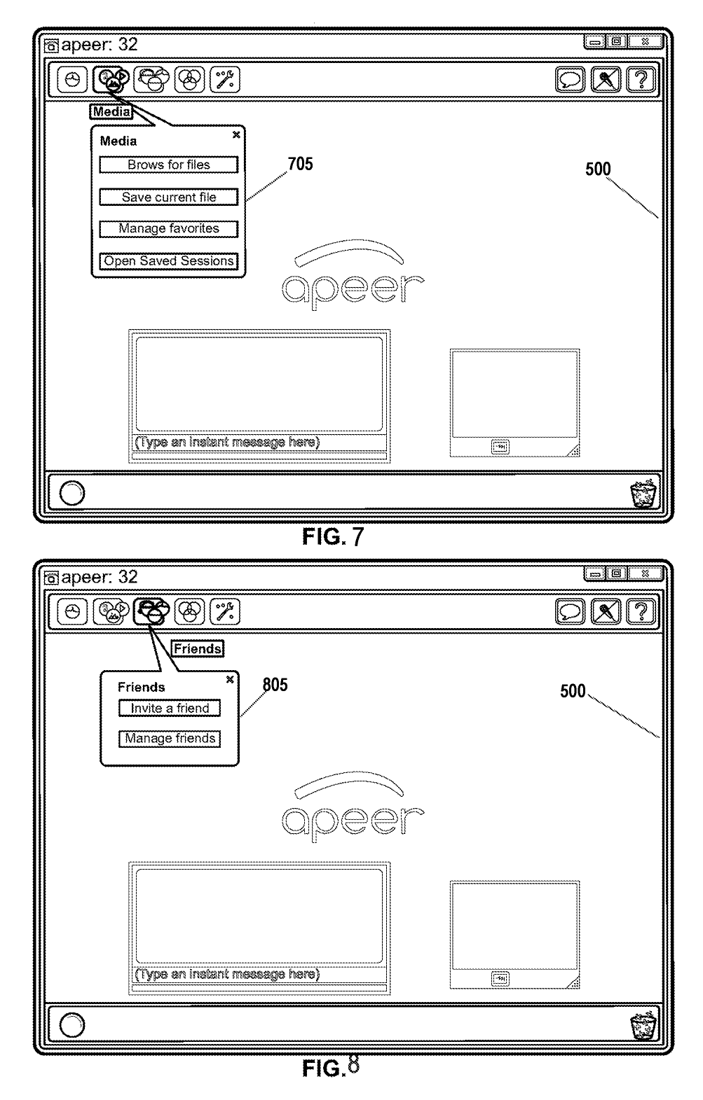

FIG. 7 illustrates menu details 705 of “media” button 525 after actuation. Options include browsing for resources (e.g., local or network), saving a current resource, managing favorite resources and sessions, and opening saved sessions.

FIG. 8 illustrates menu details 805 of “contacts” button 530 after actuation. Options include inviting another person (e.g., a contact) into the current session, as well as permitting the user to manage their social list (e.g., contact list). In a preferred embodiment for unlimited systems,

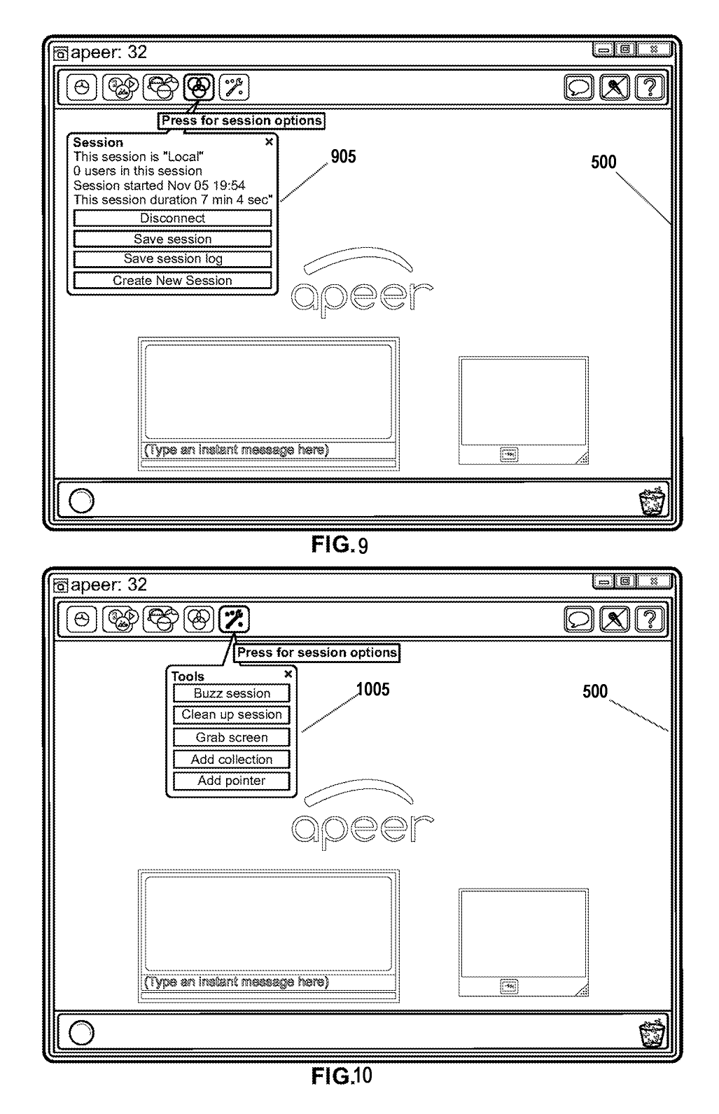

FIG. 9 illustrates menu details 905 of session button 535 after actuation. Options include session information (e.g., session status, duration, participants and the like), session control (e.g., disconnect from a session, save session, save session log, and create a new session). A session is an independent, distinct collection of participants, resources, and the like supported by local session 245 and selected using interface 500. Each session has its own dedicated independent resource space 510 and collection of renderized resources and session participants.

FIG. 10 illustrates menu details 1005 of session button 540 after actuation. Options include an announcement (e.g., “buzzer” function), session clean-up, screen grab, add collection, and add pointer functions.

Session clean-up is a single command that moves and reorganizes all of the windows within an APEER client to the border area of the APEER client.

Screen grab is a function for capturing a resource from another process (e.g., application or a web page) also operative on the APEER device. For example, when the APEER client is operative on a personal computer, it is common to provide for various programs and players for different resource types. In many collaborative systems, a user operates a file manager sub-system (typically the file manager is a tree-based paradigm requiring that the user precisely locate the desired electronic file) to tag one or more electronic files and to initiate some type of file transfer protocol to send the electronic file to one or more other users.

In contrast, interface 500 permits a user to actuate the screen grab function to identify a region of the device display not otherwise active with the APEER client. The contents of that region are immediately added into resource space 510 as a new resource, appropriate for the nature of the content of the captured region. As has been described herein, addition of a new resource into resource space 510 immediately causes the APEER system to replicate (in real-time) the resource in other of the other resource spaces of connected APEER clients in the currently active session.

The region identified with the capturing pointer may be an entire resource (e.g., an image) or simply a portion of the resource (e.g., a particular element from the image). Conventional systems would either send the entire file or require that the user create/edit/crop the desired portion of the resource, save the file, then transfer the created file.

Additionally, the region identified with the capturing pointer may include one or more resources including mixed media (e.g., image and associated text from a different file) or dynamic media (e.g., an operating player presenting a video). A preferred embodiment of screen grab is also able to transfer mixed media and dynamic media into the resource space and to thereby immediately share this type of resource as well. As is the case with the preferred embodiments of the APEER system, each resource is presented in each resource space with controls that affect the rendering of the resource in all sessions of connected sessions concurrently in real-time, and automatically. (As also described herein, it is possible to implement a master or moderator mode that provides various edit/control rights to specific users or classes of users.)

With this feature, it is possible to for one user who happens to be viewing a video on a monitor of their desktop personal computer to effortlessly share that video with other participants of the session. All active sessions receive the video concurrently, permitting all the users to synchronously and in substantial real-time watch the video together. That combined with the voice-channel feature described elsewhere herein permit the users to also discuss the video in real-time using the conferencing feature.

The add collection feature of the session option menu of tools button 540 is another novel feature of interface 500. In general, a collection is an aggregation of resources and used to help in organization and presentation. Rather than a free-form collection of resources in resource space 510, a collection is a wrapper for a set of resource that is resident in resource space 510. Any user may contribute resources into the wrapper, and any user may organize resources within the wrapper. Rather than being a sub-session, the collection also includes renderizing controls. That is, a user may render (e.g., “play”) a collection and then the resources of the collection are rendered across all active clients in substantially concurrent real-time collaboration, in the order established within the collection.

A collection is also a special wrapper in that it has the capability, in the preferred embodiment, of extracting sub-units of a resource added into the collection wrapper. A sub-unit of a resource are elements making up an aggregated resource. For example, for a multi-page PDF resource, adding this PDF into a wrapper has the ability to extract each page and make it an element in the collection. Then playing the collection will present the individual pages of the PDF rather than presenting a PDF renderer that further requires operation to access individual pages. This same feature may be enabled for other multipage document formats (e.g., powerpoint presentations where a user could drag a powerpoint into a collection and the individual slides are extracted). For unsupported format types, it is possible to include a converter to automatically convert an unsupported format into a supported format (e.g., rendering a powerpoint resource into a pdf resource). Playing the collection will then play concurrently the individual slides to all users in all connected sessions in real-time. In a preferred embodiment, this playing is responsive to simultaneous input from one or more user(s).

In a preferred embodiment, adding a video to a collection will parse the video into a collection of approximately equispaced frames of the video, details vary based upon the type of video resource. (Some video formats do not have individual frames but have interpolated data based from periodic reference units.)

The add pointer function is the ability of a user to add a curser-like “pointer” which can be placed anywhere within an APEER session window to indicate a particular point of interest to other APEER users within the session.

FIG. 11 illustrates details 1105 of actuation of an “IM” button 1110 included in menu bar 505. Options include an expanded messaging window, a virtual keyboard, and other messaging elements (e.g., emoticons and communication shortcut keys).

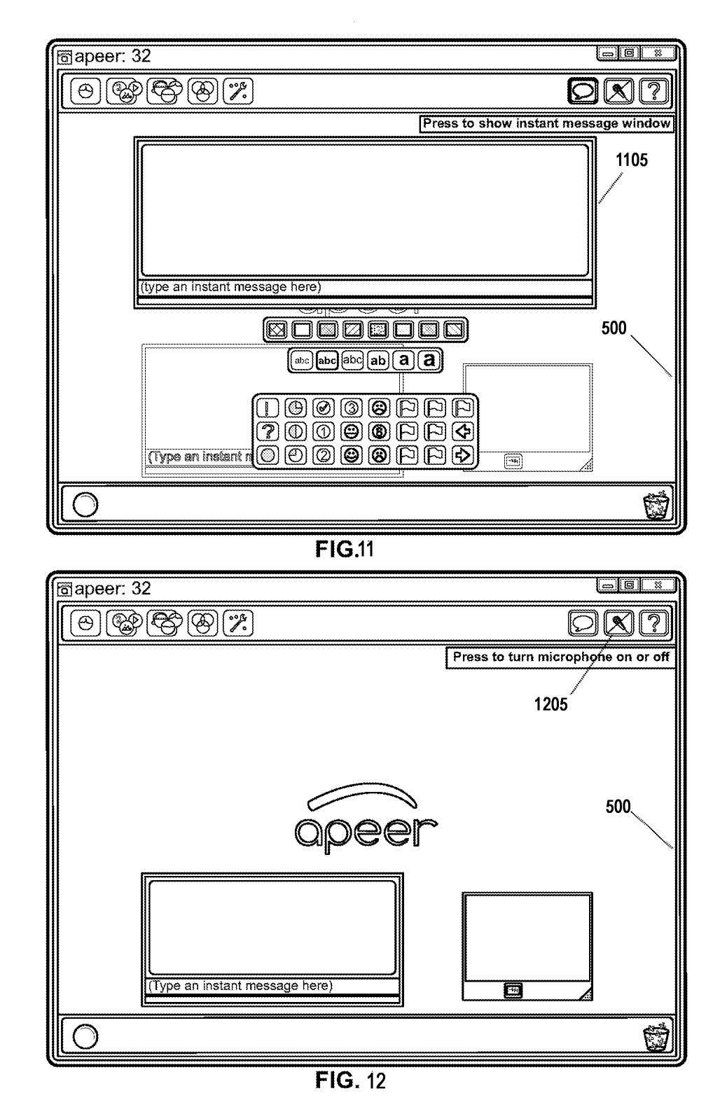

FIG. 12 illustrates a voice chat button 1210 included in menu bar 505. As noted above, interface 500 supports treatment of audio resource files as resources for replication when placed within session 510. Additionally, interface permits real-time audio to be captured and added into session 510 in substantial concurrent real-time communication. When multiple users enable this feature at the same time, a multiway real-time conference call is implemented. This has the advantage in using data network communication resources for audio distribution. This also permits audio commentary in concurrent real-time collaboration/synchronization with other renderings in session 510. Other systems require a separate audio channel to be added on top of graphical collaboration. (i.e., a user looking a shared data file on their PC must call into a conference/bridge line to discuss the shared data file.)

For example, this is particularly valuable in the context of portable cellular telephones that include data network connectivity (e.g., support a user operable web browser). In those conventional devices that are single-threaded, meaning the voice channel and the data channel are independent, it is generally not possible to use the channels concurrently. Thus a user having only a cellular telephone to review the data file would be unable to access the voice line without closing out/suspending the data channel. By adding the voice channel as another data source over the network, particularly for cellular telephone data channels, it is possible to use the cellular telephone data network for voice. Button 1205 enables/disables the voice channel provided as part of interface 500.

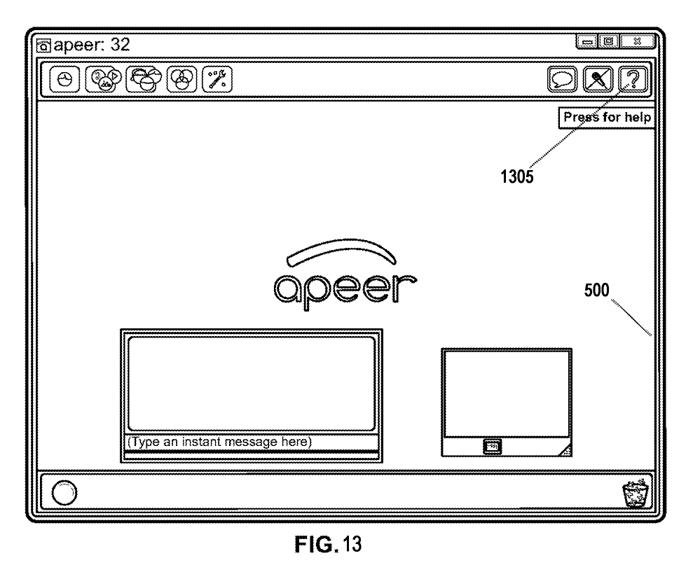

FIG. 13 illustrates a help button 1305 included in menu bar 505. Actuation of help button 1305 provides for contextual help for the various buttons, tools, and features of interface 500.

In operation, a user processes local session 675 of APEER client 245 to add one or more resources, modifies one or more resources, annotates one or more resources, sends instant messages about one or more resources, creates content in real-time (such as drawing/typing and the like in the virtual whiteboard shared across all APEER clients), creates/plays collections, grabs static/dynamic content from other applications and converts them into resources, enables/disables voice chat, and performs other supported functions. Each APEER client 245 joined to a session reproduces a layout/arrangement and content of resource windows in the individual local sessions, as close to real-time as network communications 305 permits—not just statically but also dynamically. Dynamic reproduction is when a processing in any one local session is duplicated/replicated/reformed in all the other joined local sessions in as close to real-time as network communications 305 permits and as close as possible/reasonable given different display attributes (e.g., color depth, screen resolution, and the like). For example, when an annotation is being made, the preferred embodiment exchanges messages/commands among all the several joined local sessions to duplicate the annotation as it is progressing. Border 725 may change to match the color/pattern of the user when the annotation starts and all the users see both who is doing the annotation and the results of the annotation (In other preferred implementation, a user name/cursor are “ghosted” in other session windows when the user performs some action in their session which effectively tags the user and its actions which are visible to the other users). Reproduction includes wholly replacing a resource in a state with another resource or the same resource in another state. It also includes application of resource processing directives that change the resource from a current state to the desired state to match the state of the resource in the local session of the originating APEER client, and combinations of the these two types of reproduction.

A key aspect of embodiments of the present invention includes an interactive, collaborative delivery, viewing, moving, sorting, commenting on, editing, listening, playing, and marking of images, video, audio, animation, text, rich media documents, and other objects (including any accompanying metadata), in real time, across computer platforms, networks and operating systems, and telecommunication networks, including mobile platforms and devices, concurrently by an unlimited number of users.

The many-to-many interactivity between mobile users and PC users is an important aspect of many preferred embodiments of the system. The preferred systems use a mobile data network and interrupt-driven aspects of the mobile device to attain near-real time interactivity between users.

APEER provides natural, intuitive method of interacting with visible representations of digital files by providing unrestricted, freeform movement and placement of those representations on a virtual session displayed on a screen, monitor or any viewing device. The interactivity has significant benefits in sending, receiving, communicating, collaborating, decision making, and commerce initiating, and game playing using various forms of ordinary and rich content data files.

The APEER system acts as a content communications vehicle in some preferred embodiments. APEER allows groups of individual user to communicate and collaborate using images, videos, audio, document and other digital files. APEER operates on myriad devices that are connected to networks and/or the Internet. These devices may be computers, wireless devices such as phones and PDA's (personal digital assistants), media players, gaming devices, TV set-top boxes, game consoles (e.g., XBox, PlayStations), digital imaging systems, audio capture systems, and the like. The descriptions herein focus on “PCs” and “mobile devices”—as representative of the wired and wireless classes, respectively, of supporting computing/electronic devices.

A usefulness of an APEER platform derives from a secure communication, simultaneous delivery/exchange of resources (media and other files), viewing, and collaboration paradigm with content in free-floating media windows that may be moved/processed interactively anywhere on the APEER session by any individual connected on a network to that session. APEER is used by individuals not connected to the network to collect, view, organize and comment on media files before connecting to the network in some implementations.

The APEER system acts as a media delivery channel and vessel in some preferred embodiment. APEER redefines user interaction with data as most data is currently confined to non-interactive grids and APEER places data in an appropriate environment that may be free-floating and/or fully interactive. As ADOBE's pdf was designed to provide consistent document viewing across diverse platforms, APEER's portable media format (PMF) provides consistent media collaboration across diverse platforms.

APEER provides a unique set of tools in a unique collaborative environment which allows groups of individuals to view, and interact with data (changing position of media window on screen, mark-up with drawing tools, zoom in for detailed view, comment upon with text data streams assigned to each window or a single IM chat, type text directly upon an image, place content in folders (inside a session, inside an APEER client, or outside the system using platform data storage resources) for sorting, link to other files, and create other APEER sessions). For example, users may concurrently watch/listen to video/audio resources. A user (in preferred embodiments ANY USER) may initiate/control playback of such a resource and all APEER clients respond similarly at almost exactly the same time as to be concurrent. Thus, there is no ambiguity as to which video/audio clip/segment is under discussion, and a user controls the playback of the same content in each local session of joined APEER clients (with multiple users each having some/all appropriate playback controls which can be provided based upon access rules in some implementations). In some embodiments, friends and other collaborators may be viewed as channels within a session. One user may activate a resource file (e.g., play a movie or an audio file), the other users in the session may not participate unless they opt to do so by “tuning” into that user channel.

APEER provides a real-time, fully interactive collaborative environment for work-groups, play groups, and content providers. The tools for collaboration may in some cases drive and enhance decision-making, worker productivity, and commerce. As data in the form of images, video, audio, animation, and rich media documents become ubiquitous in all sectors of business and personal life, methods of sharing and interacting with that data in natural, intuitive ways is a critical element in the development of the Digital Information Age. APEER provides such an interface.

The session is an area that is a metaphor for a traditional tabletop. Items that can be placed on the session include images, documents, videos, sound files, animations, digital files, and folders. The items may be represented by thumbnails inside objects called “media windows.” Image and document thumbnails may be resized. When implemented, folders may be shown in a graphical form, with a “representative” image or document embedded. The representative image may be created by and/or chosen by the user. Any particular implementation preferably supports multiple diverse media formats natively in a session window, based upon provided renderizers (e.g. as part of the OS or client or other). Unsupported resources may still be exchanged/reproduced in other clients.

Media windows are freely movable and resizable within the session. Objects may overlap and obscure other objects. Objects are not permitted to extend outside a perimeter of the session. Objects may be dragged onto the session from other “dialog box” windows or imported using APEER “dialogbox” windows. Each local session has a Tools button which accesses tools appropriate for the session and session objects.

Objects on a local session may be “selected”—their media window “frame” is represented in a manner to identify an operating user (e.g. ghosted user info, color, or the like), most preferably used to identify the user making such a selection or operation. The usual conventions of Shift-select and Cntrl-select will extend the selection to multiple objects. The session contents, positions and sizes are persistent and saved across login sessions.

Content is sent as individual data files or groups of files from computer to computer, mobile device to mobile device, computer to mobile device, and mobile device to computer in some preferred embodiments. There is no compromise accessing data in the mobile or PC/desktop environment. APEER provides a common interface across all platforms. A local session of an APEER may be used as an always on/always connected interface through which data is sent and received as needed or continuously. Arrival of new data may be signaled visually, by the appearance of a new media window in the local session, by an instant message, by a sound, vibration or other prompts and the like.

APEER frees data from static grids and introduces a concept of free-floating windows of data which may be simultaneously controlled by both local and remote users for the purposes including concurrent viewing, listening, markup, collaboration, communication, linking to other data, servers, web servers, and the like.

Media files sent through or resident on the APEER system may be linked to other files, high-resolution files and streaming media files resident on any system anywhere in some preferred embodiments. For example, low-resolution thumbnail images may be linked to high-resolution image files that may be resident on any system anywhere. Those linked high-resolution files may be used for such applications as printing and viewing on high resolution and/or large format screens.

Low-resolution images, videos, or short video clips may be linked to high resolution and/or full-length images, videos or video streams for viewing or initiating an eCommerce purchase or license to own, view or use the media file in some preferred embodiments. High-resolution image, audio and video files are delivered directly through the APEER system. Collections of audio and video samples are displayed and played through APEER and the user may select the file they want to download or stream to a specified device. APEER is used to play and display full resolution media files such as video, audio, still image, animation, games, and the like.

Other applications and implementations are well within the scope of the present invention. A reference—“GOING VISUAL, Using images to enhance productivity, decision making and profits,” by Alexis Gerard and Bob Goldstein. Published in 2005 by John Wiley & Sons. ISBN 0-471-71025-3, is hereby expressly incorporated by reference in its entirety for all purposes will aid in further understanding of some of the conclusions and usefulness of the preferred embodiments of the present invention.

In the preceding discussion, certain ones of the embodiments of the present invention have included a discussion of reproducing a media resource across each of a set of messaging clients. Other embodiments of the present invention include substantial synchronization of a rendering of a media resource across all of the APEER clients in a session, responsive to one or more collaboration messages that may be received from any APEER client (and in some cases received at any time including when another APEER client is issuing its own collaboration message).

In these other embodiments, some key elements include true multi-way, real-time (substantially) renderings of the media resource across all the clients. Some embodiments provide for the rendering controls to be actively distributed (for example, one client may initiate the rendering and another client may stop the rendering, or for more complex controls, any client may start, stop, pause, fast forward, and/or fast rewind a rendering of a media resource, while in other implementations some or all of the controls are limited to some participants, and provision is made in some cases for dynamically assigning “control” rights/permissions to specific users or classes of users. In still other instances, it is provided for the collaboration messages to synchronize a desired reference of the media resource to all of the clients so the nearly identical rendering of the resource occurs at all connected clients. A preferred embodiment of the present invention permits any user to control rendering of the media resource on all APEER clients in substantial synchronization (synchronization that is in unison but for minor communications delays of the communications systems). As noted above, any user may start, stop, rewind, fast forward or operate any other rendering control appropriate for the media, including operating such a rendering control for those renderings initiated or operated by one or more other users.

Herein, when discussing a rendering of a media resource, this concept is considered in the broadest sense. Often, rendering is taken to be applicable to image resources in which a data file (still (e.g., jpeg, gif, or the like) or streaming format (mpeg, avi, wmf or the like) is processed to produce a particular image or image sequence. A rendering system receives the image resource and, based upon the format of the media resource, generates the particular image on an output system (display, printer, or the like). For other media resources, rendering is also used to convert a digital format into a perceptible representation. A media resource includes a document file (word processing, spreadsheet, presentation, and the like) in which a rendering produces the document in a human-readable format. A media resource includes an audio file format (MP-3 and the like) in which a rendering produces the audio file format human-hearing format. The conversion of a machine-readable format to a human-perceivable format encompasses rendering, the specifics of any rendering dependent upon the type of media resource and the desired sense to be used for perceiving the converted format.

When implementing synchronization embodiments as described herein, APEER clients exchange one or more collaboration messages (directly with one another or indirectly through an APEER server or other intermediary system) to synchronize the rendering(s), and specifically to synchronize one or more renderings to desired reference points of the media resource. These collaboration messages effectuate the delivery/exchange, synchronization, and response of the rendering of the media resource to the distributed rendering controls so one operator may unambiguously present the same specific rendering of the media resource on all connected APEER clients. In the preferred embodiment, these controls are available to all users at all times permitting true unrestricted simultaneous multi-way, real-time, unambiguous collaboration of one or more media resources, though other configurations are noted above.

Preferred embodiments, including some of those described herein, include renderizers that are responsive to one or more control signals. An example of a renderizer includes CODECs (compression/decompression and/or coder/decoder algorithms and processes) used in digital media for a digital data stream or signal.

CODECS (in the modern, software sense) encode a stream or signal for transmission, storage or encryption and decode it for viewing or editing. CODECs are often used in videoconferencing and streaming media applications. A video camera's analogue-to-digital converter (ADC) converts its analogue signals into digital signals, which are then passed through a video compressor for digital transmission or storage. A receiving device then runs the signal through a video decompressor, then a digital-to-analogue converter (DAC) for analogue display. A “codec” is a generic name for a video conferencing unit.

An audio compressor converts analog audio signals into digital signals for transmission or storage. A receiving device then converts the digital signals back to analog using an audio decompressor, for playback. An example of this are the codecs used in the sound cards of personal computers. The raw encoded form of audio and video data is often called essence, to distinguish it from the metadata information that together make up the information content of the stream and any “wrapper” data that is then added to aid access to or improve the robustness of the stream.

Most codecs are lossy. Originally this was in order to make the compressed files small enough to be readily transmitted across non-broadband networks and stored on relatively expensive media, such as non-volatile memory and hard disk as opposed to write-once read-many formats such as CD-ROM and DVD. There are also lossless codecs, but for most purposes the slight increase in quality might not be worth the increase in data size, which is often considerable. The main exception to this is when the data undergoes further processing (for example editing) in which case the repeated application of lossy codecs (repeated encoding and subsequent decoding) will almost certainly degrade the quality of the edited file such that it is readily identifiable (visually or audibly or both). Using more than one codec or encoding scheme while creating a finished product can also degrade quality significantly (however there are many situations where this is all but unavoidable). The decreasing cost of storage capacity and network bandwidth may obviate the need for lossy codecs for some media over time.

Codecs are often designed to emphasize certain aspects of the media to be encoded. For example, a digital video (using a DV codec) of a sports event, such as baseball or soccer, needs to encode motion well but not necessarily exact colors, while a video of an art exhibit needs to perform well encoding color and surface texture. There are hundreds or even thousands of codecs ranging from those downloadable for free to ones costing hundreds of dollars or more. This can create compatibility and obsolescence issues. By contrast, lossless PCM audio (44.1 KHz, 16 bit stereo, as represented on an audio CD or in a .wav or .aiff file) offers more of a persistent standard across multiple platforms and over time.

Many multimedia data streams need to contain both audio and video data, and often some form of metadata that permits synchronization of this audio to the video. Each of these three streams may be handled by different programs, processes, or hardware; but for the multimedia data stream to be useful in stored or transmitted form, they must be encapsulated together in a container format.

The widely spread notion of AVI being a codec is incorrect as AVI (nowadays) is a container format, which many codecs might use (although not to ISO standard). There are other well known alternative containers such as Ogg, ASF, QuickTime, RealMedia, Matroska, DivX, and MP4. As used herein, renderizer includes codecs, containers, and other formats for visualizing/audibilizing/presenting a media resource to a user.

These renderizers often include control elements appropriate for the type of media rendered, and many operating systems and processing environments include built-in codecs appropriate to common media resources. It is also possible to supplement built-in codecs by provision of codecs appropriate to a particular media resource or to provide an additional or desirable rendering function.

As noted herein, it is an aspect of many embodiments of the present invention to provide for real-time synchronized rendering of one or more media resources in multiple communications clients (e.g., the APEER clients). One way that this is achieved is to provide a synchronization subsystem with each client that, responsive to user-input using the interface, issues control signals to a local renderizer to render the media resource. (In some circumstances, the rendering is of a time-varying content (e.g., a video stream or audio stream) or a time-varying rendering (e.g., of annotating, commenting on a still photo or document, or just repositioning/resizing the media resource in the interface)). The media resource is rendered locally in a particular way on one of the clients by a user. The synchronization subsystem communicates equivalent control information to the other communications clients to have the local renderizers render a local copy of the media resource in each communications client substantially the same. The degree to which the renderizers are equivalent and respond to the same or equivalent rendering control signals, and the latency and communication method of exchanging the rendering control signals result in the degree of real-time synchronization of the rendering of the media resources on all of the communications clients.

It is also an important aspect for some embodiments that the control signals are multi-way, meaning that any user is able to create a time-varying content to the same or different media resource, and to have that rendering be synchronized on all the other communications clients. In essence, each communications client creates a composite rendering from all the synchronized rendering control signals applicable to a particular media resource.

This reflects another important aspect of many embodiments of the present invention: that a media resource added into an interface of one communications client is automatically recreated in the interfaces of connected communications clients participating in the same session. The local renderizers then are permitted to render, responsive to the synchronized rendering control signals, the media resource in each client.

In some implementations, conventional codecs are used with a synchronizing interface “wrapper” to provide real-time synchronized multi-client renderings of one or more media resources. In other implementations, special synchronizing codecs are provided that integrate the codec/synchronizing/communications to other special synchronizing codec included in another communications clients.

As noted herein, the codecs need not be exactly the same in the other communications clients, as the degree of compatibility and responsive and fidelity to the exchanged synchronizing rendering control signals results in the degree of the real-time synchronized rendering of the media resource(s). This model permits, when appropriate or desirable, different platforms (e.g., personal computer and PDA) to have renderizers appropriate to each platform and thus maximize the real-time collaboration experience by compatibly Tenderizing the media resource(s) on each platform responsive to the exchanged synchronizing rendering control signal(s).

Another important aspect of embodiments of the present invention is that the interface supports renderizers for different formats of multiple resource files directly. That means that the media resources are each rendered within the interface with the other resources. And an exact copy (as possible with the communications latency and processing/communication/distribution of the synchronizing rendering control signals(s)) of the renderings of the multiple media resources are duplicated in all the communications clients of participating session users. Separate rendering windows are not used as the media resources, and any time-varying element(s), are all rendered in the single interface, and then synchronized in real-time with the other communications clients.

The system above has been described in the preferred embodiment including an APEER server and a plurality of APEER clients. In alternate preferred embodiments, the APEER clients communicate via a peer-to-peer communications system in addition to or in lieu of Server/Client communications. Additionally, in some embodiments there is value in a system including a single APEER client communicated to an APEER server.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A system, comprising:
a communications network, coupled to a first plurality of ports, for communicating a second plurality of media resources, said second plurality of media resources including resources implemented in at least two different media formats; and
a third plurality of real-time messaging clients coupled to said first plurality of ports of said communications network, each of said clients including both a communications subsystem for receiving said second plurality of media resources and an interface for rendering all of said second plurality of media resources, each said client producing renderings of said media resources in its interface in substantial synchronization resource renderings in all said other interfaces of all other said clients.

2. The system of claim 1 wherein said communications network relays one or more collaboration messages from one of said first plurality of ports to other ones of said first plurality of ports; wherein each said real-time messaging client receives said one or more collaboration messages; and wherein a particular one of said collaboration messages is transmitted by one of said messaging clients at a desired reference of one of said renderings and each other of said messaging clients substantially synchronizes said particular one collaboration message with said desired reference.

3. An apparatus, comprising:
a communications network, coupled to a first and a second port, for communicating a media resource; and
a first and second real-time communication client, coupled respectively to said first and second ports, each of said clients including:
a communications subsystem for receiving said media resource;
a renderizer subsystem, responsive to a control signal, for rendering said media resource;
an interface for generating said control signal; and
a synchronization subsystem for communicating said control signal;
wherein a first one of said communications clients generates said control signal and communicates said control signal to said second one communications client to render said media resource in substantial synchronization on said communications clients.

4. The apparatus of claim 3 wherein said media resource includes a time-varying content and wherein said renderizer subsystem renders said time-varying content over a period.

5. The apparatus of claim 4 wherein said interface includes a renderizer control for including timing control elements in said control signal, said timing control elements including one or more of the controls selected from a group consisting essentially of stop, play, fast-forward, reverse, and combinations thereof.

6. The apparatus of claim 3 wherein said renderizer subsystem provides a time-varying rendering of said media resource.

7. The apparatus of claim 6 wherein said interface includes a renderizer control for including time-varying control elements in said control signal, said time-varying control elements including one or more of the controls selected from a group consisting essentially of zoom, rotate, flip, edit, annotate, comment, embed, and combinations thereof.

8. The apparatus of claim 3 wherein said communications network includes a communications server coupled to each of said clients for communicating said control signal.

9. The apparatus of claim 3 wherein said interface of said first communications client receives said media resource and wherein said synchronization subsystem synchronizes reproduction of said media resource in said interface of said second communications client and wherein said renderizer of said second communication client renders said reproduced media resource in said second communications client substantially synchronized to rendering of said media resource in said first communications client.

10. The apparatus of claim 9 wherein both of said communications clients generate one of said control signals and, for each generated control signal, a non-generating communications client receives said generated control signal and synchronizes said rendering of said media resource responsive to said generated control signal wherein said renderings of both media resources is substantially synchronized in both said communications clients.

11. The apparatus of claim 10 wherein said control signals are cogenerated simultaneously from said communications clients.

12. The apparatus of claim 3 wherein both of said communications clients generate one of said control signals and, for each generated control signal, a non-generating communications client receives said generated control signal and synchronizes said rendering of said media resource responsive to said generated control signal wherein said renderings of both media resources is substantially synchronized in both said communications clients.

13. The apparatus of claim 12 wherein said control signals are cogenerated simultaneously from said communications clients.

14. An apparatus, comprising:
a communications network, coupled to a first and a second port, for communicating a media resource wherein said media resource includes a time-varying content over a period; and
a first and second real-time communication client, coupled respectively to said first and second ports, each of said clients including:
a communications subsystem for receiving said media resource;
a renderizer subsystem, responsive to a control signal, for rendering said time-varying content over said period;
an interface for generating said control signal; and
a synchronization subsystem for communicating said control signal;
wherein one of said communications clients generates said control signal and communicates said control signal to said other communications client to render said time-varying content over said period in substantial synchronization on said communications clients.

15. A method, the method comprising:
a) receiving a first media resource at a first communications client;
b) reproducing said first media resource at a second communications client;
c) rendering, responsive to a first rendering control signal, said first media resource at said first client to generate a first rendered media resource;
d) rendering, responsive to a second rendering control signal, said first media resource at said second client to generate a second rendered media resource;
e) communicating said first rendering control signal to said second communications client;
f) communicating said second rendering control signal to said first communications client;
g) rendering said first rendered media resource using said second rendering control signal to create a first composite rendered media resource at said first communications client; and
h) rendering said second rendered media resource using said first rendering control signal to create said first composite rendered media resource at said second communications client substantially synchronized with said rendering of said first rendered media resource.

16. The method of claim 15 further comprising:
a) receiving a second media resource at said second communications client, said second media resource including a media format different from said first media resource;
b) reproducing said second media resource at said first communications client;
c) rendering, responsive to a third rendering control signal, said second media resource at said first client to generate a third rendered media resource;
d) rendering, responsive to a fourth rendering control signal, said second media resource at said second client to generate a fourth rendered media resource;
e) communicating said third rendering control signal to said second communications client;
f) communicating said fourth rendering control signal to said first communications client;
g) rendering said third rendered media resource using said fourth rendering control signal to create a second composite rendered media resource at said first communications client; and
h) rendering said fourth rendered media resource using said third rendering control signal to create said second composite rendered media resource at said second communications client substantially synchronized with said rendering of said third rendered media resource.

17. A method, the method comprising:
a) receiving a first media resource at a first communications client and a second communications client;
b) generating a first rendering control signal using an interface of said first communications client;
c) rendering, responsive to said first rendering control signal, said first media resource at said first client to generate a first rendered media resource;
d) communicating said first rendering control signal to said second communications client as a first communicated rendering control signal;
e) rendering, responsive to said first communicated rendering control signal, said first media resource at said second communications client in substantial synchronization with said first media resource rendering at said first communications client.

18. The method of claim 17 wherein said first media resource includes a time-varying content and wherein said renderizers render said time-varying content over a period.

19. The method of claim 18 wherein said interfaces include a renderizer control for including timing control elements in said rendering control signals, said timing control elements including one or more of the controls selected from a group consisting essentially of stop, play, fast-forward, reverse, and combinations thereof.

20. The method of claim 17 wherein said renderizers provide a time-varying rendering of said first media resource.

21. The method of claim 20 wherein said interfaces include a renderizer control for including time-varying control elements in said rendering control signals, said time-varying control elements including one or more of the controls selected from a group consisting essentially of zoom, rotate, flip, edit, annotate, comment, embed, and combinations thereof.

22. The method of claim 17 wherein a communications server, coupled to each of said communications clients, communicates said rendering control signals to said clients.

23. The method of claim 17 wherein said interface of said first communications client receives said media resource and wherein said synchronization subsystem synchronizes reproduction of said media resource in said interface of said second communications client and wherein said renderizer of said second communication client renders said reproduced media resource in said second communications client substantially synchronized to rendering of said media resource in said first communications client.

24. The method of claim 23 wherein both of said communications clients generate one of said control signals and, for each generated control signal, a non-generating communications client receives said generated control signal and synchronizes said rendering of said media resource responsive to said generated control signal wherein said renderings of both media resources is substantially synchronized in both said communications clients.

25. The method of claim 24 wherein said control signals are cogenerated simultaneously from said communications clients.

26. The method of claim 17 wherein both of said communications clients generate one of said control signals and, for each generated control signal, a non-generating communications client receives said generated control signal and synchronizes said rendering of said media resource responsive to said generated control signal wherein said renderings of both media resources is substantially synchronized in both said communications clients.

27. The method of claim 26 wherein said control signals are cogenerated simultaneously from said communications clients.

28. A computer program product comprising a computer readable medium carrying program instructions for operating a system when executed using a computing system, the executed program instructions executing a method, the method comprising:
a) receiving a first media resource at a first communications client;
b) reproducing said first media resource at a second communications client;
c) rendering, responsive to a first rendering control signal, said first media resource at said first client to generate a first rendered media resource;
d) rendering, responsive to a second rendering control signal, said first media resource at said second client to generate a second rendered media resource;
e) communicating said first rendering control signal to said second communications client;
f) communicating said second rendering control signal to said first communications client;
g) rendering said first rendered media resource using said second rendering control signal to create a first composite rendered media resource at said first communications client; and
h) rendering said second rendered media resource using said first rendering control signal to create said first composite rendered media resource at said second communications client substantially synchronized with said rendering of said first rendered media resource.

29. A computer program product comprising a computer readable medium carrying program instructions for operating a system when executed using a computing system, the executed program instructions executing a method, the method comprising:
a) receiving a first media resource at a first communications client and a second communications client;
b) generating a first rendering control signal using an interface of said first communications client;
c) rendering, responsive to said first rendering control signal, said first media resource at said first client to generate a first rendered media resource;
d) communicating said first rendering control signal to said second communications client as a first communicated rendering control signal;
e) rendering, responsive to said first communicated rendering control signal, said first media resource at said second communications client in substantial synchronization with said first media resource rendering at said first communications client.
